(19) United States
(12) Patent Application Publication
(10) Pub. No.: US 2018/0236652 A1
(43) Pub. Date: Aug. 23, 2018

(54) MANUAL HAND CRANK WITH OPTIONAL POWER ENHANCEMENT

(71) Applicant: Alternative Engineering, Inc., Belmont, MI (US)

(72) Inventors: D. Robert Rodriguez, Ada, MI (US); John R. McClary, Comstock Park, MI (US); Michael J. Panik, Grand Rapids, MI (US)

(73) Assignee: Alternative Engineering, Inc.

(21) Appl. No.: 15/440,684

(22) Filed: Feb. 23, 2017

(51) Int. Cl. B25H 1/16; B25H 1/02; A47B 9/00; A47B 9/10

(52) U.S. Cl. CPC B25H 1/16; A47B 9/10; A47B 9/00; B25H 1/02

(57) ABSTRACT

A worktable having an adjustable height using a manual hand crank includes a table top, base section and a support leg extending between the table top and base section. One or more jacks are configured within the support leg and are adjustable in length. A bearing assembly is used for rotating the jack(s) to raise and lower the table top in relation to the base. The bearing assembly includes a shaft for rotating the jack(s) where the bearing assembly is configurable between a retracted and extended position for concealment under the table top edge when not in use. The hand crank may be enhanced so that it is optionally rotated using an electric drill or air tools.

### FIELD OF THE INVENTION

The present invention relates generally to industrial work tables and more particularly to a height adjustable finishing stand having a manual hand crank.

### BACKGROUND

Industrial work tables are commonly used in the art for all types of work jobs and projects. However, adjusting the height of the table can be often be burdensome where the table can require disassembly. Even when tables are designed for height adjustment, movement of the table height with heavy weight on its top surface can be difficult in view of the lifting mechanism.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a perspective view of a height adjustable finishing stand with manual hand crank according to an embodiment of the invention.

FIG. 2 is a side view illustrating the adjustment of the leg jack.

FIG. 3 is a magnified exploded view of the hand crank.

FIG. 4 is a perspective view of the leg jack used in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a height adjustable finishing stand with manual hand crank. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. It is expected that one of ordinary skill, notwithstanding possibly significant effort and many design choices motivated by, for example, available time, current technology, and economic considerations, when guided by the concepts and principles disclosed herein will be readily capable of generating such mechanical components with minimal experimentation.

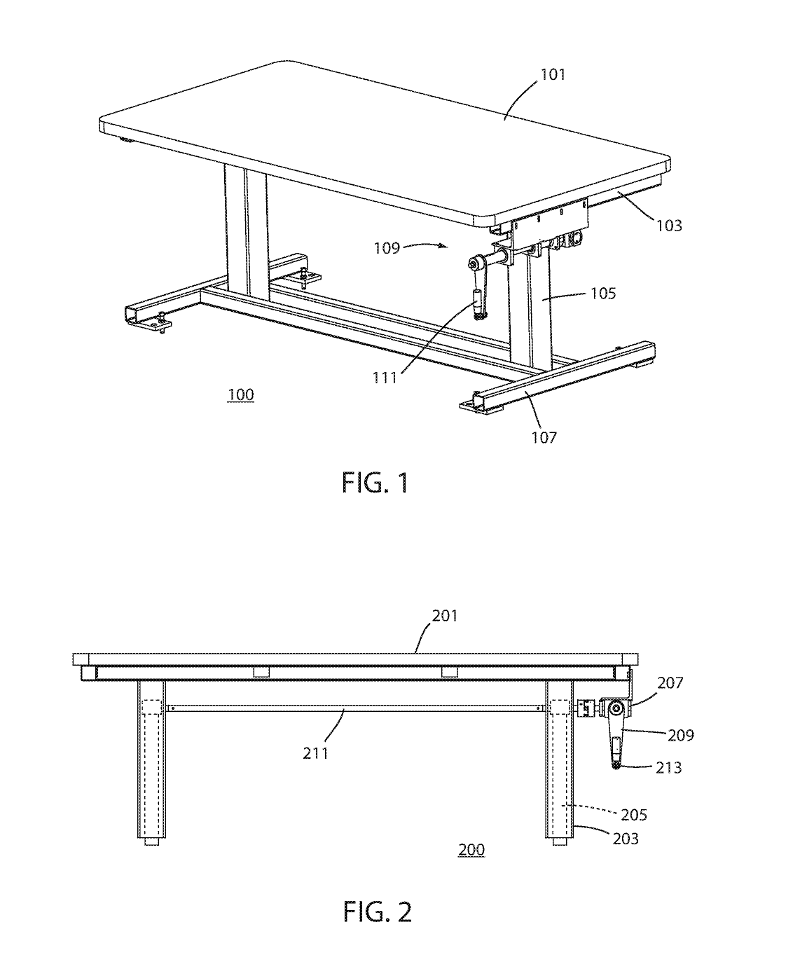

FIG. 1 is a perspective view of a height adjustable finishing stand with manual hand crank according to an embodiment of the invention. The finishing stand 100 includes a table top 101 that is support by a table frame top 103. The table frame top 103 extends around the underside perimeter of the table top 101. A plurality of support legs 105 are attached to both the frame 103 and a table frame bottom 107. the table frame bottom 107 is double T shaped whose legs extend outwardly parallel with the table end. The table frame bottom 107 is configured in such a manner to provide support for a substantially heavy weight on the table top 101 and prevents the finishing table from tipping to its side. As will be described herein, a height adjustment mechanism 109 includes a manual and foldable hand crank 111 for easily allowing the operator to raise and lower the table by cranking the adjustment mechanism 109 with minimal effort.

FIG. 2 illustrates a side view of the height adjustable work table 200 that includes a table top surface 201 that is supported one or more support legs 203. A leg jack 203, which is adjustable in length, is configured within a support leg 203 and connects to a bearing mechanism 207. The bearing mechanism 207 connects to the jack 203 using an axle 211. As seen in FIG. 2, the axle 211 extends between one or more of the supports legs 203 and rotates with the bearing mechanism 207 to raise and lower the table top surface 201 in relation to the ground. As each of two jacks are turned within each support leg 203, the jack's overall length is extended or retracted to raise or lower the table respectively.

In use, a crank 209 and handle 213 are used to rotate the bearing mechanism. The bearing mechanism 207 includes a novel feature where the shaft holding the crank can be easily retracted. This allows the crank 209 to be pushed under the table's edge and out of the work space. The handle 213 connects to the crank 208 and is foldable so that it is substantially parallel with the crank to conceal it while it is not in use. Moreover, the table can also be raised or lowered by turning the manual crank by using an electric or air drill using a socket such as ⅝ inch or the like. The drill is connected to a center screw on the crank and turned in the manner a user would manually turn the crank using their own strength. This give the crank a power enhancement option enabling it to be quickly raised or lowered without manually turning the crank.

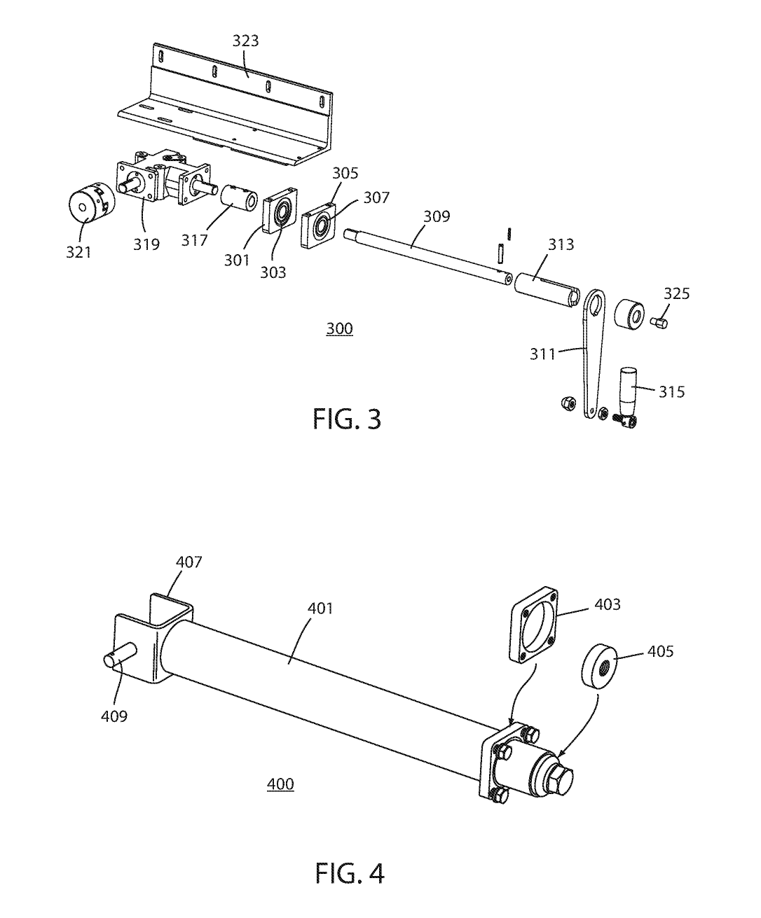

FIG. 3 is an exploded view of the bearing mechanism as used in connection with an embodiment of the invention. The bearing mechanism 300 includes a first bearing mount 301 having a first ball bearing 303 as well as a second bearing mount 305 and second ball bearing 307. A crank 311 connected to the bearings 303, 307 though a handle shaft 309. A sleeve 313 connects the crank 311 allowing the shaft 309 to be easily rotated. A foldable handle 315 connects to the distal end of the crank 311 and folds so that it is substantially parallel and positioned longitudinally with the crank body. The distal end of the handle shaft 309 connects to a coupler 317. The coupler 317 connects the handle shaft 309 to gearbox 319. Gearbox 319 also connects to coupling spider 321 that connects to the leg jack. The gearbox 319 is geared so that the rotational motion of the handle shaft 309 turns the spider 321 at some predetermined gear ratio such as 1:1 or 2:1. For example, one turn of the handle shaft 309 will rotate the spider 321 two turns. Thus, the gearbox 319 provides an orthogonal translation of motion from the crank 311 to the at least one jack (FIG. 4).

A bracket 323 is used to fasten the bearing assembly 300 under the table top. In use, the crank 311 can move in an extended or retracted position. The crank 311 moves on the sleeve 313 so that it can be pushed inwardly to a retracted position or move outwardly to its extended position. A user will turn the crank 311 using the handle 315 when in the extended position. Alternatively, an electric drill or air gun (not shown) can be attached to fastening screw 325 to turn the handle shaft 313 enabling the user to quickly move the table up or down.

FIG. 4 is a perspective view of one of the two hydraulic leg jacks used in accordance with the invention. Those skilled in the art will recognize that a hydraulic jack consists of two connected cylinders, one big and one small, where force is applied to the smaller cylinder that creates equal pressure in both cylinders. Since the large cylinder has a larger area, the large cylinder produces greater force. By applying force to the small cylinder, the force is amplified in the bigger cylinder. Thus, the jacks used in the present invention can be used to lift heavy loads placed upon the work table. As seen in FIG. 4, the jack 400 as used in connection with the invention has a jack body 401 where one end of the jack utilizes a jack mount 403 and bottom mount 405 for connecting the jack at one end to with a support leg. The opposite end of the jack 400 uses a u-bracket to connect with the gearbox 319. The spider 321 connects this rotational shaft for lengthening and shortening the overall length of the jack 400. This enables the distance of the table surface to be variable between the table frame bottom.

Thus, embodiments of the invention are directed to a height adjustable work table and method of forming the table that include a table top supported by a base. One or more support leg are used and extend between the table top and base where each of the legs has a jack therein that is extendable in length. A bearing assembly is used for rotating the jack and the bearing mechanism is rotated with a crank having a collapsible handle such that a shaft connects to the crank and the crank is configurable between a retracted and extended position to conceal the crank under the table top when not in use.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A worktable having an adjustable height using a manual crank comprising:
a table top;
a base;
a support leg extending between the table top and base;
at least one jack configured within the support leg;
a bearing assembly for rotating the at least one jack with a manual crank to raise and lower the table top in relation to the base; and
wherein the bearing assembly includes a shaft for rotating the at least one jack that is configurable between a retracted and extended position.

2. A worktable as in claim 1, wherein handle is foldable to be substantially parallel with the crank.

3. A worktable as in claim 1, wherein the bearing assembly includes a first bearing and second bearing for supporting shaft.

4. A worktable as in claim 1, wherein the bearing assembly includes a gearbox for orthogonally translating motion from the crank to the at least one jack.

5. A worktable as in claim 1, wherein the at least one jack is a hydraulic jack.

6. A worktable as in claim 1, wherein the crank includes a handle that is configurable under an edge of the table top when in an retracted position.

7. A worktable as in claim 1, wherein the bearing assembly includes a fastener configured concentric with the crank for attachment by a powered device.

8. A worktable as in claim 7, wherein the powered device is an electric or pneumatic powered tool.

9. A height adjustable table with crank comprising:
a table top supported by a base;
at least one support leg extending between the table top and base having at least one jack configured therein;
a bearing assembly for rotating the jack; and
wherein the bearing assembly is rotated with a crank having a collapsible handle such that a shaft connects to the crank and the crank is configurable between a retracted and extended position.

10. A height adjustable table as in claim 9, wherein the crank is positioned under an edge of the table top when in the retracted position.

11. A height adjustable table as in claim 9, wherein the bearing assembly includes a first bearing and second bearing for supporting the shaft.

12. A height adjustable table as in claim 9, wherein the bearing mechanism includes a gearbox for providing orthogonal translation of motion from the crank to the at least one jack.

13. A height adjustable table as in claim 9, wherein the at least one jack is a hydraulic jack.

14. A height adjustable table as in claim 9, wherein the bearing assembly includes a fastener configured concentrically with the crank for attachment by a powered device.

15. A height adjustable table as in claim 14, wherein the powered device is an electric or pneumatic tool.

16. A method for adjusting the height of a worktable surface using a manual crank comprising the steps of:
providing a table top;
providing a base section;
configuring at least one support leg between the table top and the base section where the at least one support leg includes a jack with a manual crank for adjusting the length of the at least one support leg;
attaching a bearing assembly to the jack;
rotating the bearing assembly using a shaft; and
configuring the shaft so that it is configurable in a retracted position under the table top or in an extended position outside of the table top.

17. A method for adjusting the height of a worktable surface as in claim 16, further comprising the step of:
utilizing a gearbox with the bearing assembly for orthogonally translating motion from the crank to the at least one jack.

18. A method for adjusting the height of a worktable surface as in claim 16, further comprising the step of:
attaching a handle to the crank so that the handle can be folded substantially parallel with the crank.

19. A method for adjusting the height of a worktable surface as in claim 17, further comprising the step of:
providing a fastener configured concentrically with the crank for attachment by a powered device to turn the bearing assembly.

20. A method for adjusting the height of a worktable surface as in claim 16, further comprising the step of;
attaching an electric or pneumatic power tool to the fastener for controlling the overall length of the jack.
